(19) United States
(12) Patent Application Publication
(10) Pub. No.: US 2026/0225198 A1
(43) Pub. Date: Aug. 6, 2026

(54) MACHINE TOOL

(71) Applicant: Schwäbische Werkzeugmaschinen GmbH, Schramberg-Waldmössingen (DE)

(72) Inventors: Thomas FONTAINE, Niedereschach (DE); János BUDAI, Ballószög (HU); Damian MARMOL, Chelmiec (PL); Pascal BITTNER, Villingendorf (DE)

(21) Appl. No.: 19/530,960

(22) Filed: Feb. 5, 2026

(30) Foreign Application Priority Data
Feb. 6, 2025 (EP) 25156127.0

(51) Int. Cl. B23Q 3/157; B23Q 3/155

(52) U.S. Cl. CPC B23Q 3/15724; B23Q 3/1554; B23Q 2003/155414

(57) ABSTRACT

A machine tool with a work spindle which extends along a spindle axis and on which a first tool can be fixed directly to the work spindle and a second tool can be fixed directly to the first tool, and a tool changing device which has a first holding means to which a first tool can be fixed and which can be arranged or is arranged at a change position of the work spindle. The work spindle can be moved for automatically picking up or releasing a first tool from the first holding means, and to which the first holding means can be moved. The tool further includes a second holding means to which a second tool can be secured and which can be arranged or is arranged at the change position of the work spindle or at a further change position of the work spindle.

### CROSS-REFERENCE

This application claims the benefit of European application EP 25156127.0 filed February 6, 2025, which is incorporated herein by reference.

### The invention is a machine tool

Machine tools are known from the prior art in which a first tool and a second tool can be arranged on a work spindle. In conventional machine tools, the work spindle is moved to a changeover position and automatically picks up a first tool there, which is provided, for example, by a tool magazine. With this first tool, a workpiece can then be machined using the work spindle.

It is also known from the prior art to manually arrange a second tool on a work spindle on which a first tool is already fixed. This is fixed on one side of the first tool facing away from the work spindle, for example by means of a screw.

Manually attaching a second tool to a first tool, or again manually removing a second tool from the first tool, has proven to be complex and time-consuming.

### SUMMARY

One task of an exemplary embodiment of the invention is to propose a machine tool in which the picking up and releasing of a second tool is simplified.

This task is solved by a machine tool with at least one work spindle extending along a spindle axis, on which a first tool can be fixed directly to the work spindle and a second tool can be fixed directly to the first tool for machining workpieces along the spindle axis, and with at least one tool changing device, which has at least one first holding means, to which at least one first tool can be fixed and which can be arranged or is arranged at a changeover position of the work spindle, to which the work spindle can be moved for automatically picking up or releasing a first tool from the first holding means and in the other case to the first holding means, and which comprises at least one second holding means to which at least one second tool can be attached and which can be arranged or is arranged at the change position of the work spindle or at a further change position of the work spindle, to which the work spindle with the first tool attached thereto can be moved for automatically picking up or releasing a second tool from the second holding means and in the other case to the second holding means.

The fact that the work spindle can be moved to pick up a first tool from the first holding means or to deliver a first tool arranged on the work spindle to the first holding means, to the change position and to pick up a second tool or deliver a second tool to the change position or a further change position, and that the picking up or delivering is carried out automatically, further automates the tool change. This can reduce changeover times and simplify tool changes. In particular, the automatic switching between the first and second tools can save personnel.

The fact that a first tool can be arranged on the work spindle and a second tool on the first tool expands the possibilities for machining a workpiece to be machined by the machine tool.

The work spindle can be designed in such a way that it is moved parallel or perpendicular to the spindle axis by a translational movement when machining workpieces. Furthermore, embodiments of the machine tool are also conceivable in which the work spindle rotates around the spindle axis to machine a workpiece.

In order to change or arrange a first tool and/or a second tool, it proves advantageous if the first holding means is arranged in a first transfer position in the change position of the work spindle, in which a first tool to be picked up by the work spindle, in particular with a first contact surface extending transversely or obliquely to the spindle axis; rests in contact with the work spindle and/or when the second holding means is arranged in the change position of the work spindle or the further change position in a second transfer position, in which a second tool to be received by the work spindle, in particular with a second contact surface running transversely or obliquely to the spindle axis; rests on the first tool in contact on a side of the first tool facing away from the work spindle.

To automatically arrange the first tool on the work spindle and the second tool on the first tool, an embodiment of the machine tool comprises at least one first fixing unit, which has a first receptacle in the work spindle or in the first tool, at least one first projection element that can be fixed or is fixed to the first tool and in the other case to the work spindle and that can be inserted into the first receptacle parallel to the spindle axis, and which comprises at least one automatic first joining means by which the first projection element can be transferred, at least in the arrangement inserted into the first receptacle, into a rear engagement position in which the first projection element is fixed in the first receptacle against movement parallel to the spindle axis, and/or by at least one second fixing unit, which has a second receptacle in the first tool or in the second tool, which has at least one second projection element that can be fixed or is fixed to the second tool and in the other case to the first tool, and which can be inserted into the second receptacle parallel to the spindle axis, and which comprises at least one automatic second joining means by means of which the second projection element can be moved, at least in the arrangement inserted into the second receptacle, into a rear engagement position in which the second projection element is fixed in the second receptacle against movement parallel to the spindle axis.

The word "or" is used in its original form. Here, it means "and in the other case" and not "or".

In principle, it is conceivable that the first projection element, when arranged on the first tool, forms a common, single-piece component together with the first tool. The same applies if the first projection element is fixed on the work spindle. Also in such a case, the first projection element and the work spindle can form a common, single-piece component.

Furthermore, embodiments are conceivable in which the first projection element comprises a component separate or separable from the first tool and in the other case from the first work spindle, for example a bolt or a screw.

Similarly, the second projection element, which is fixed to the second tool, can form a common, single-piece component together with the second tool. If the second projection element is fixed to the first tool, the second projection element and the first tool can form a common, single-piece component.

Furthermore, embodiments are conceivable in which the second projection element comprises a component that is separate or separable from the second tool and in the other case the first tool, for example a bolt or a screw or the like.

Furthermore, embodiments of the machine tool prove to be advantageous in which the changeover position of the work spindle is always the same or in which several changeover positions of the work spindle lie in a common plane. In this case, it may prove advantageous if the first holding means and the second holding means of the tool changing device run parallel to each other in a plane transverse to the spindle axis, at least in the area of the first transfer position and the second transfer position, and/or in which the second transfer position of the second holding means is offset relative to the first transfer position of the first holding means in a direction parallel to the spindle axis by at least the length of the first tool in the direction of the spindle axis away from the work spindle.

This enables the work spindle always to be moved to the same change level in the changeover position, regardless of whether a first tool or a second tool is picked up. When a second tool is picked up, a first tool is already positioned on the work spindle.

In embodiments of the machine tool, the tool changing device is designed to comprise a common support structure extending substantially transversely to the spindle axis, to which the first holding means is directly attached, and at least one spacer means attached to the support structure, on which the second holding means is arranged and by means of which the at least one second holding means is spaced apart from the first holding means in a direction parallel to the spindle axis by at least the length of the first tool in the direction of the spindle axis, or that the tool changing device has a first support structure extending substantially transversely to the spindle axis, on which the first holding means is directly fixed, and a second support structure extending substantially transversely to the spindle axis, to which the second holding means is directly attached, wherein the first support structure and the second support structure are spaced apart from each other by the length of the first tool in the direction of the spindle axis at least in the region of the first transfer position and the second transfer position.

If the at least one first holding means and the at least one second holding means are arranged on the common support structure, the spacer means can ensure that the second holding means is offset relative to the drive spindle. The spacer means may be designed as an arm or a beam and form a load-bearing support from the common supporting structure to the second holding means.

If the tool changing device comprises a first support structure and a second support structure, the at least one first holding means and the at least one second holding means may be held independently of one another.

The at least one first holding means and the at least one second holding means may be arranged to be immovable and fixed in relation to the machine tool. In this case, if more than one first holding means is provided, each possible first holding means is approached by the drive spindle. Each of the several first holding means is thus assigned a changeover position.

This applies equally if several second holding means are provided. If the multiple second holding means are arranged in a fixed and immovable manner relative to the machine tool, they can be approached by the work spindle to the multiple changeover positions assigned to the respective second holding means.

The changeover position to be approached by the work spindle may comprise a single changeover position if each support structure of the tool changing device comprises at least one transfer means, wherein the first holding means can be moved by one of the at least one transfer means to the at least one changeover position of the work spindle, and wherein the second holding means can be moved by the transfer means or by a further transfer means to the changeover position of the work spindle or a further changeover position of the work spindle.

In this case, the first holding means and the second holding means are moved by the transfer means so that the first holding means or the second holding means, on which the first tool and in the other case the second tool to be picked up by the work spindle is to be picked up, is moved to the changeover position of the work spindle.

By assigning at least one transfer means, the changeover positions of the work spindle can thus be limited to a maximum of two changeover positions, wherein a first changeover position for receiving and delivering the first tools is arranged on the first holding means and a second changeover position associated with the second tools is arranged on the second holding means, when the machine tool comprises two support structures, namely a first support structure carrying the first holding means and a second support structure carrying the second holding means.

Furthermore, embodiments of the machine tool are conceivable in which at least one of the at least one first holding means and/or at least one of the at least one second holding means are decoupled and can be moved independently of one another by the at least one transfer means into the at least one changeover position of the work spindle, and/or in which at least one of the at least one first holding means and/or at least one of the at least one second holding means are coupled to each other and can be moved dependently of each other by the at least one transfer means into the at least one changeover position of the work spindle.

This makes it possible for either all holding means to be movable individually by the transfer means, or for several, in particular all, holding means to be transferable to the “changeover position of the work spindle” by one and the same transfer means or by their own transfer means respectively.

Embodiments of the machine tool prove to be advantageous in which the first support structure of the tool changing device comprises at least one first transfer means, on which at least one of the at least one first holding means is fixed in position, and in which the tool changing device comprises at least one first drive, through which the first transfer means can be moved and the at least one first holding means can be moved to the changeover position of the work spindle, in particular the first transfer position, and in which the second support structure of the tool changing device comprises at least one second transfer means, to which at least one of the at least one second holding means is fixedly attached and in which the tool changing device comprises at least one second drive by means of which the second transfer means can be moved and the at least one second holding means can be moved to the changeover position of the work spindle, in particular the second transfer position.

As an alternative to the aforementioned embodiment with two transfer means, the machine tool can be designed to be compact and with fewer components if the common support structure of the tool changing device comprises at least one common transfer means, to which at least one of the at least one first holding means is fixedly attached and to which at least one of the at least one second holding means is fixedly attached, and if the tool changing device comprises at least one common drive, through which the common transfer means can be moved and the at least one first holding means, in particular to the first transfer position, and the at least one second holding means, in particular to the second transfer position, can be moved to the at least one changeover position of the work spindle.

This means that at least one first holding means and at least one second holding means are arranged on the same common transfer means. These can then be moved together and coupled with each other or separated from each other and independently of each other by the common guide means to the changeover position of the work spindle.

It proves to be advantageous if the first transfer means and the second transfer means of the tool change device run parallel to each other at least in the area of the first transfer position and the second transfer position, or if the common transfer means of the tool change device comprises the spacer means on which the second holding means is arranged.

Both measures ensure that the work spindle can always be moved to the same changeover position, where it can either pick up a first tool from the first holding device or deliver a first tool to the first holding device, or, if a first tool is already positioned on the work spindle, pick up a second tool or deliver a second tool at the same changeover position.

The first holding means and/or second holding means can be easily moved by the transfer means if the common transfer means of the tool changing device comprises a common guide rail, in which the first holding means is guided with a first slide section and in which the spacer means is guided with a spacer means slide section along a common transfer direction running transversely or obliquely to the spindle axis, or if the first transfer means and the second transfer means of the tool changing device each comprise a guide rail, in which the first holding means can be moved along a first transfer direction running transversely or obliquely to the spindle axis by means of a first slide section, and in the other case in which the second holding means can be moved along a second transfer direction running transversely or obliquely to the spindle axis by means of a second slide section.

In order to fix a first tool and/or a second tool securely by means of the first holding means and in the other case the second holding means, it is advantageous if the first holding means is designed in the form of a gripper and comprises at least two first gripper arms, by means of which at least one first tool can be fixed in a gripping position by means of a force-fit and/or form-fit, and at least one first release means, by means of which the first gripper arms can be moved into a release position in which a first tool can be removed from the first holding means or arranged on the first holding means, and/or if the second holding means is designed as a gripper and comprises at least two second gripper arms, by means of which at least one second tool can be secured in a gripping position by force and/or form-fitting, and comprises at least one second release means, by means of which the second gripper arms can be moved into a release position in which a second tool can be removed from the second holding means or arranged on the second holding means.

In order to ensure that the first tool and in the other case the second tool is always held securely, it is advantageous if the first holding means comprises at least one first clamping means, by which the at least two first gripping arms are preloaded into the gripping position and/or if the second holding means comprises at least one second clamping means by which the at least two second gripping arms are preloaded into the gripping position and/or if the first release means comprises a first stamp element which rests against the first clamping means, and/or if the second release means comprises a second stamp element which rests against the second clamping means, wherein the first release means and/or the second release means can be acted upon mechanically, pneumatically, hydraulically or electrically with a release force counteracting the clamping force of the first clamping means and in the other case the second clamping means.

Since the first holding means comprises at least one first clamping means and since the second holding means comprises at least one second clamping means, by means of which the at least two first gripping arms and in the other case the at least two second gripping arms are preloaded into the gripping position, the respective tool is held securely even when the machine tool is de-energised, depressurised or similar.

Since the first holding means comprises a first release means and the second holding means comprises a second release means, which are mutually counteractive in the first clamping means and in the other case the second clamping means, respectively, the first holding means and in the other case the second holding means can be actively controlled to release the first tool and in the other case the second tool, respectively.

If the second holding means is spaced apart from the transfer means by a spacer means, it proves particularly advantageous if the second release means comprises at least one channel-like recess in the spacer means, which in particular forms a guide for a medium, such as an electrical cable or fluid, from the common transfer means to the second release means.

This allows the medium required to activate the second release means, such as an electrical cable or fluid, in particular gas or liquid, to be transported to the second holding means within the channel-like recess in the spacer means.

A further development of the machine tool comprises at least one tool magazine, which is assigned to the tool changing device or which is formed by the tool changing device, and in which at least one first tool and at least one second tool can be stored.

Further features, details and advantages of the invention are apparent from the appended patent claims, from the drawing and from the following description of a preferred embodiment of the machine tool.

### BRIEF DESCRIPTION OF THE DRAWINGS

The drawing shows:

FIG. 1 A perspective top view of an exemplary embodiment of the machine tool;

FIG. 2 A detailed perspective view of the machine tool according to FIG. 1 in the area of the changeover position of the work spindle;

FIG. 3 A perspective side view of a second holding means with spacer means;

FIG. 4 A sectional view through a first holding means according to FIG. 1.

### DETAILED DESCRIPTION

The figures show areas and components of a machine tool designated by reference number 2. This comprises a work spindle 4 extending along a spindle axis 6. A first tool 8 can be fixed directly to the work spindle 4 and a second tool 10 can be fixed directly to the first tool 8 on the work spindle 4 for machining workpieces along the spindle axis 6.

In addition, the machine tool 2 comprises a tool changing device 12, which, in the exemplary embodiments shown in the figures, comprises a plurality of first holding means 14. A first tool 8 can be fixed to each of the first holding means 14.

In the exemplary embodiment shown in the figures, the first holding means 14 can be moved by a common transfer means 16 into a changeover position of the work spindle 4, at which the work spindle 4 can be moved for the automatic picking up or releasing a first tool 8.

In addition, the machine tool 2 shown in the figures comprises at least one second holding means 18 to which at least one second tool 10 can be fixed. The second holding means 18 can be moved to the changeover position of the work spindle 4 by means of the common transfer means 16 and, when the second holding means 18 is positioned at the changeover position of the work spindle 4, is arranged to pick up or release a second tool 10. This enables the work spindle 4, on which a first tool 8 is already arranged, to receive a second tool 10 from the second holding means 18 in one and the same change position, and in the other case to return it to the second holding means 18.

The figures show an exemplary embodiment of machine tool 2, in which tool changing device 12 comprises the common transfer means 16. Both the plurality of first holding means 14 and the second holding means 18 are arranged on these. For this purpose, the transfer means 16 comprises a common guide rail 20, on which the first holding means 14 can be guided with corresponding slide sections that correspond to the common guide rail 20, in particular complementarily.

The individual first holding means 14 and the second holding means 18 can be arranged in the changeover position of the work spindle 4 by moving them along the common guide rail 20. In the common change position of the work spindle 4, a first holding means 14 is arranged in a first transfer position in which a first tool 8 to be picked up by the work spindle 4, in particular with a contact surface extending transversely or obliquely to the spindle axis 6, rests in contact with the work spindle 4. The second holding means 18 can be arranged by the common transfer means 16 in the change position of the work spindle 4 in a second transfer position, in which a second tool 10 to be picked up by the work spindle 4, in particular with a second contact surface extending transversely or obliquely to the spindle axis 6, rests in contact on the first tool 8 on a side of the first tool 8 facing away from the first work spindle 4.

The first transfer position of the first holding means 14 and the second transfer position of the second holding means 18 are offset in a direction parallel to the spindle axis 6 by a length of the first tool 8 in the direction of the spindle axis 6 away from the work spindle 4. For this purpose, the tool changing device 12 of the machine tool 2 comprises a spacer 22, which is guided and held in the common guide rail 20 by a spacer means slide section 24, and the second holding means 18 is arranged on a side opposite the spacer slide section 24.

In order to be able to move the common transfer means 16, the tool changing device 12 comprises a common drive 26, with which the first holding means 14 and the second holding means 18 can be moved in a chain or trolley-like manner essentially in a plane at an angle to the first spindle axis 6.

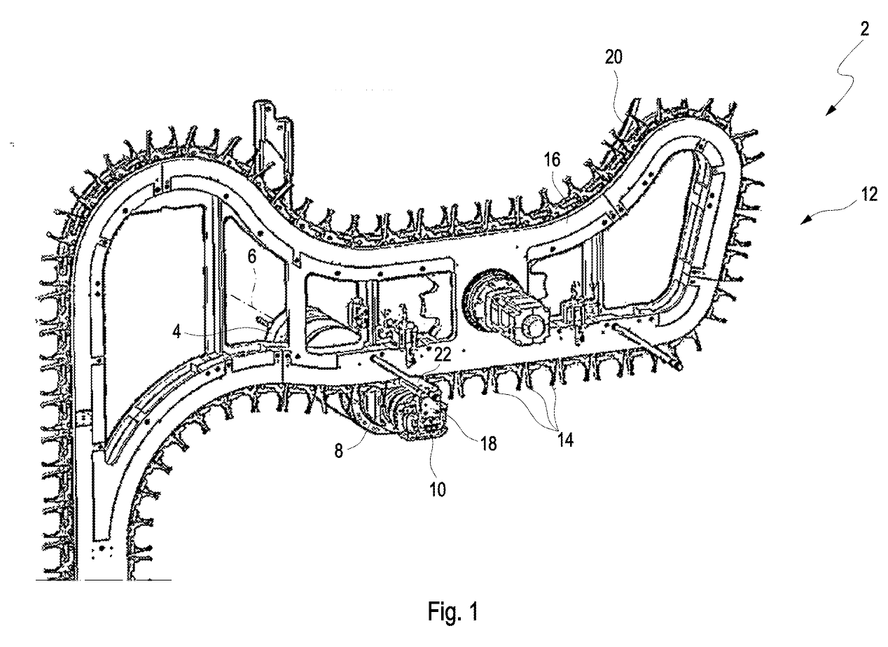

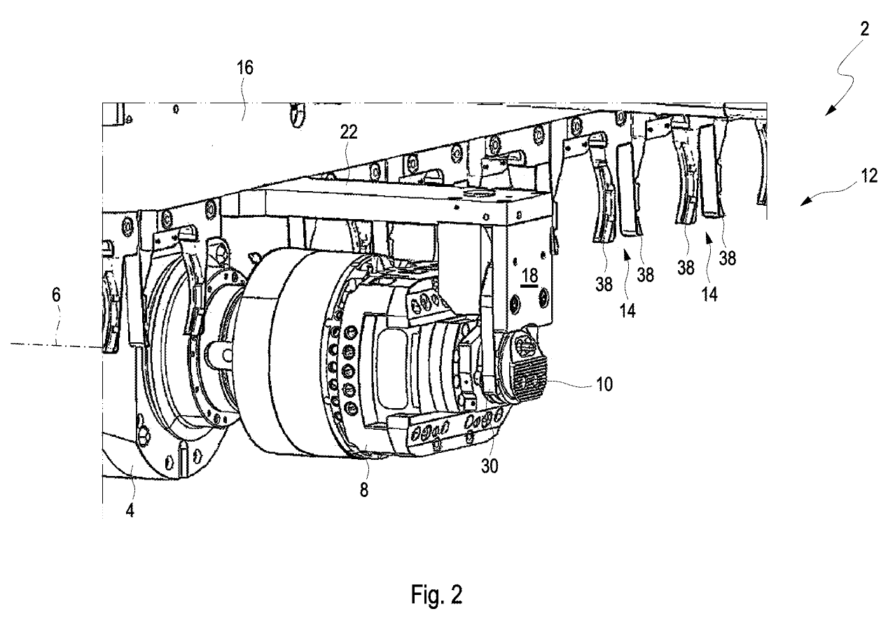

FIGS. 1 and 2 show that a second tool 10 can be arranged and secured on a first tool 8 arranged on the work spindle 4. To secure the first tools 8 to the work spindle 4, the machine tool 2 comprises a first fixing unit, not shown in detail, which enables a first tool 8 to be secured automatically to the work spindle 4.

Similarly, the tool changing device 12 comprises a second fixing unit, not shown in detail, with which a second tool 10 can be automatically clamped directly to the first tool 8. By directly fixing the second tool 10 to the first tool 8, the second tool 10 is indirectly fixed to the work spindle 4.

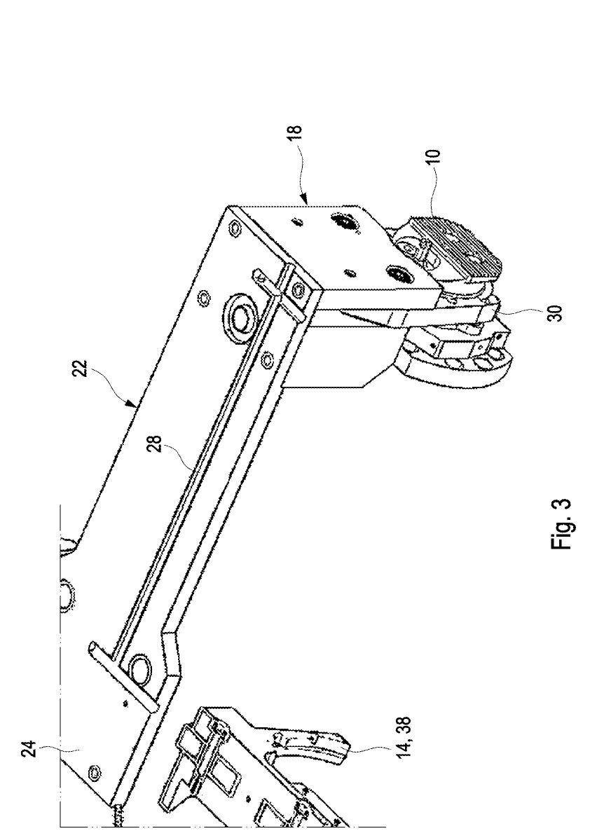

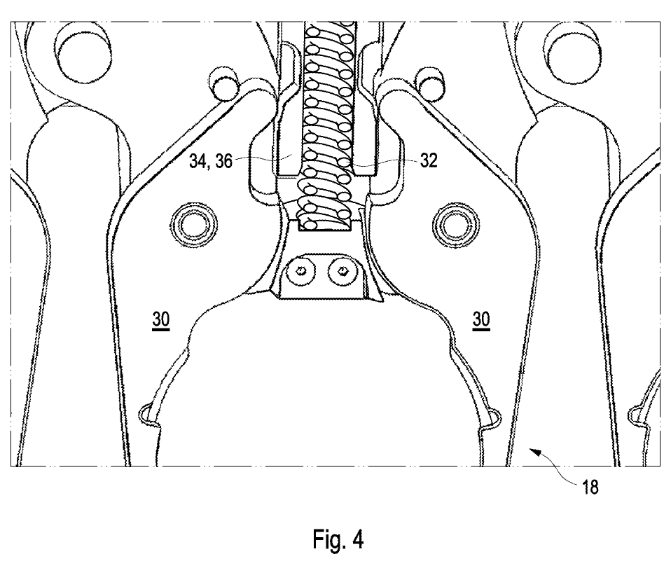

FIGS. 3 and 4 show detailed views of a second holding means 18. FIG. 3 shows that a channel-like recess 28 may be arranged in the spacer means 22. This makes it possible to guide a medium, such as an electrical cable or a fluid, from the common transfer means 16 towards the second holding means 18.

FIG. 2 shows, using the example of the second holding means 18, that this is designed in the form of a gripper. For this purpose, it may comprise two second gripping arms 30, which are preloaded into a gripping position by a second clamping means 32. In the gripping position, the two gripping arms 30 can rest against a second tool 10 and hold it in a force-fitting and/or form-fitting manner.

To release the two second gripping arms 30 from the gripping position, the second holding means 18 comprises a second release means 34, which is designed in the form of a stamp. The second release means 34, which is designed as this second stamp element 26, can then be actuated, for example mechanically, pneumatically, hydraulically or electrically and can be subjected to a release force that counteracts the clamping force of the second clamping means 32 and thereby moves the two second gripper arms 30 into a release position in which a second tool 10 can be removed from the second holding means 18.

Similarly, the first holding means 14 are equipped with corresponding first gripping arms 38. As with the second holding means 18, these are provided with similar kinematics and comprise first clamping means and first release means (not explicitly shown in the figures).

FIG. 3 in particular shows that arranging the second holding means 18 by means of the spacer 22 in the second transfer position makes it possible to remove the second tool 10 from the first tool or to fix it to the first tool 8, wherein the work spindle 4 can always be arranged at one and the same changeover position. To fix a first tool 8 on the work spindle 4 or a second tool 10 on the work spindle 4, the work spindle 4 must always be moved to the same changeover position, regardless of whether a first tool 8 or a second tool 10 is being fixed.

The features of the invention disclosed in the above description, in the claims and in the drawing may be essential for the realisation of the invention in its various embodiments, both individually and in any combination, within the scope of protection of the following claims.

### REFERENCE SYMBOL LIST

2 Machine tool

4 Work spindle

6 Spindle axis

8 First tool

10 Second tool

12 Tool changing device

14 First holding means

16 Common transfer means

18 Second holding means

20 Common guide rail

22 Spacer means

24 Spacer means slide section

26 Common drive

28 Channel-like recess

30 Second gripper arm

32 Second clamping device

34 Second release means

36 Second stamp element

38 First gripper arm

1. A machine tool comprising:
at least one work spindle extending along a spindle axis, on which, for machining workpieces along the spindle axis, a first tool can be fixed directly to the work spindle and a second tool can be fixed directly to the first tool, and
at least one tool changing device which has at least one first holding means to which at least one of the first tool can be fixed and which can be arranged or is arranged at a changeover position of the work spindle, to which the work spindle can be moved for automatically picking up or releasing a first tool from the first holding means, and in the other case to the first holding means, and which comprises at least one second holding means, to which at least one second tool can be attached and which can be arranged or is arranged at the change position of the work spindle or another change position of the work spindle, to which the work spindle with the first tool fixed to it can be moved for automatic picking up or releasing of a second tool from the second holding device, and in the other case to the second holding device.

2. The machine tool according to claim 1, wherein the first holding means is arranged in the changeover position of the work spindle in a first transfer position in which a first tool to be picked up by the work spindle; rests in contact with the work spindle and/or that the second holding means is arranged in the change position of the work spindle or the further change position in a second transfer position, in which a second tool to be received by the work spindle, rests against the first tool on a side of the first tool facing away from the work spindle.

3. The machine tool according to claim 1, wherein at least one first fixing unit, which has a first receptacle in the work spindle or in the first tool, which has at least one first projection element, which is fixed or can be fixed to the first tool and in the other case the work spindle and which can be inserted into the first receptacle parallel to the spindle axis, and which comprises at least one automatic first joining means, by means of which the first projection element can be moved, at least in the arrangement introduced in the first receptacle, into a rear engagement position in which the first projection element is fixed in the first receptacle against movement parallel to the spindle axis, and/or by at least one second fixing unit, which comprises a second receptacle in the first tool or in the second tool, at least one second projection element which can be fixed or is fixed to the second tool and in the other case to the first tool and which can be inserted into the second receptacle parallel to the spindle axis, and at least one automatic second joining means, by means of which the second projection element can be moved, at least in the arrangement introduced into the second receptacle, into a rear engagement position in which the second projection element is fixed in the second receptacle against movement parallel to the spindle axis.

4. The machine tool according to claim 2, wherein the first holding means and the second holding means of the tool change device run parallel to each other in a plane transverse to the spindle axis, at least in the area of the first transfer position and the second transfer position and/or that the second transfer position of the second holding means is offset relative to the first transfer position of the first holding means in a direction parallel to the spindle axis by at least the length of the first tool in the direction of the spindle axis away from the work spindle.

5. The machine tool according to claim 1, wherein the tool changing device comprises a common support structure extending substantially transversely to the spindle axis, to which the first holding means is directly attached, and at least one spacer means which is fixed to the supporting structure, on which the second holding means is arranged and by means of which the at least one second holding means is spaced apart in the direction parallel to the spindle axis at least by the length of the first tool in the direction of the spindle axis to the first holding means, or that the tool changing device has a first support structure extending substantially transversely to the spindle axis, to which the first holding means is directly attached, and a second support structure extending substantially transversely to the spindle axis and to which the second holding means is directly attached, wherein the first support structure and the second support structure are spaced apart from each other by the length of the first tool in the direction of the spindle axis at least in the region of the first transfer position and the second transfer position.

6. The machine tool according to claim 5, wherein each support structure of the tool changing device comprises at least one transfer means, wherein the first holding means can be moved by one of the at least one transfer means to the at least one changing position of the work spindle and wherein the second holding means can be moved by the transfer means or by a further transfer means to the changeover position of the work spindle or to a further changeover position of the work spindle.

7. The machine tool according to claim 6, wherein at least one of the at least one first holding means and/or at least one of the at least one second holding means can be decoupled and moved independently of each other by the at least one transfer means into the at least one change position of the work spindle and/or that at least one of the at least one first holding means and/or at least one of the at least one second holding means are coupled to each other and can be moved dependently of each other by the at least one transfer means into the at least one change position of the work spindle.

8. The machine tool according to claim 5, wherein the first support structure of the tool changing device comprises at least one first transfer means, to which at least one of the at least one first holding means is fixedly attached, and that the tool changing device comprises at least one first drive, through which the first transfer means can be moved and the at least one first holding means can be moved to the changeover position of the work spindle, and that the second support structure of the tool changing device comprises at least one second transfer means, to which at least one of the at least one second holding means is fixedly attached, and that the tool changing device comprises at least one second drive, by means of which the second transfer means can be moved and the at least one second holding means can be moved to the changeover position of the work spindle.

9. The machine tool according to claim 5, wherein the common support structure of the tool changing device comprises at least one common transfer means on which at least one of the at least one first holding means is securely fixed and on which at least one of the at least one second holding means is securely fixed, and that the tool changing device comprises at least one common drive by which the common transfer means is movable and the at least one first holding means, and the at least one second holding mean to which at least one change position of the work spindle is movable.

10. The machine tool according to claim 8, wherein the first transfer means and the second transfer means of the tool changing device run parallel to each other at least in the area of the first transfer position and the second transfer position, or that the common transfer means of the tool changing device comprises the spacer means on which the second holding means is arranged.

11. The machine tool according to claim 8, wherein the common transfer means of the tool changing device comprises a common guide rail, in which the first holding means is guided to move with a first slide section and in which the spacer means is guided to move with a spacer means slide section along a common transfer direction running transversely or obliquely to the spindle axis or that the first transfer means and the second transfer means of the tool changing device each comprise a guide rail, in which the first holding means is guided to move along a first transfer direction which runs transversely or obliquely to the spindle axis with a first slide section, and in the other case in which the second holding means is guided to move along a second slide section which runs transversely or obliquely to the spindle axis.

12. The machine tool according to claim 1, wherein the first holding means is designed as a gripper and comprises at least two first gripper arms, by means of which at least one first tool can be secured in a gripping position by force and/or form-fitting, and at least one first release means, by means of which the first gripper arms can be moved into a release position in which a first tool can be removed from the first holding means or arranged on the first holding means, and/or that the second holding means is designed like a gripper and comprises at least two second gripper arms, by means of which at least one second tool can be secured in a gripping position by force and/or form-fitting, and at least one second release means, by means of which the second gripping arms can be moved into a release position in which a second tool can be removed from the second holding means or arranged on the second holding means.

13. The machine tool according to claim 12, wherein the first holding means comprises at least one first clamping means by which the at least two first gripping arms are preloaded into the gripping position and/or that the second holding means comprises at least one second clamping means, by which the at least two second gripping arms are preloaded into the gripping position and/or that the first release means comprises a first stamp element which rests against the first clamping means, and/or that the second release means comprises a second stamp element which rests against the second clamping means, wherein the first release means and/or the second release means can be applied mechanically, pneumatically, hydraulically or electrically with a release force counteracting the clamping force of the first clamping means and in the other case the second clamping means.

14. The machine tool according to claim 13, wherein the second release means comprises at least one channel-like recess in spacer means, which forms a guide for a medium from the common transfer means to the second release means.

15. The machine tool according to claim 1, wherein at least one tool magazine which is assigned to the tool changing device or which is formed by the tool changing device, and in which at least one first tool and at least one second tool can be stored.
